(19) United States
(12) Patent Application Publication
(10) Pub. No.: US 2010/0316801 A1
(43) Pub. Date: Dec. 16, 2010

(54) THIN FILM DEPOSITION APPARATUS

(75) Inventors: Choong-Ho LEE, Yongin-city (KR); Jung-Min Lee, Yongin-city (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-city (KR)

(21) Appl. No.: 12/813,786

(22) Filed: Jun. 11, 2010

(30) Foreign Application Priority Data
Jun. 12, 2009 (KR) 10-2009-0052357

(51) Int. Cl. B05D 1/02; B05C 5/00

(52) U.S. Cl. 427/256; 118/313

(57) ABSTRACT

A thin film deposition apparatus that can be simply applied to produce large substrates on a mass scale and that improves manufacturing yield includes a deposition source; a first nozzle that is disposed at a side of the deposition source and includes a plurality of first slits arranged in a first direction; a second nozzle that is disposed opposite to the first nozzle and includes second slits arranged in the first direction; and a barrier wall assembly that is disposed between the first nozzle and the second nozzle in the first direction, and includes barrier walls that partition a space between the first nozzle and the second nozzle into sub-deposition spaces. A distance between the adjacent second slits is different.

### CROSS-REFERENCE TO RELATED APPLICATION

This application claims the benefit of Korean Patent Application No. 10-2009-0052357, filed Jun. 12, 2009 in the Korean Intellectual Property Office, the disclosure of which is incorporated herein by reference.

### BACKGROUND

1. Field

Aspects of the present invention relate to a thin film deposition apparatus, and more particularly, to an apparatus for depositing a thin film on a substrate.

2. Description of the Related Art

Organic light-emitting display devices have a larger viewing angle, better contrast characteristics, and a faster response rate than other display devices. Thus, organic light-emitting display devices have drawn attention as a next-generation display device.

Organic light-emitting display devices generally have a stacked structure including an anode, a cathode, and an emission layer interposed between the anode and the cathode. The devices display images in color when holes and electrons, injected respectively from the anode and the cathode, recombine in the emission layer and thus light is emitted. However, it is difficult to achieve high light-emission efficiency with such a structure. As such, intermediate layers are optionally included. Examples of the intermediate layers include an electron injection layer, an electron transport layer, a hole transport layer, a hole injection layer, etc. The intermediate layers are additionally interposed between the emission layer and each of the electrodes.

An organic light-emitting display device thus includes intermediate layers as well as an emission layer between a first electrode and a second electrode that are arranged opposite to each other. The electrodes and the intermediate layers may be formed via various methods, one of which is a deposition method. When an organic light-emitting display device is manufactured by using the deposition method, a fine metal mask (FMM) having the same pattern as a thin film to be formed is disposed to closely contact a substrate. A thin film material is deposited over the FMM in order to form the thin film having the desired pattern.

### SUMMARY

Aspects of the present invention provide a thin film deposition apparatus that may be easily manufactured, that may be simply applied to manufacture large-sized display devices on a mass scale, that improves manufacturing yield and deposition efficiency, and that allows deposited materials to be reused.

According to an aspect of the present invention, there is provided a thin film deposition apparatus including: a deposition source; a first nozzle that is disposed at a side of the deposition source and includes a plurality of first slits arranged in a first direction; a second nozzle that is disposed opposite to the first nozzle and includes a plurality of second slits arranged in the first direction; and a barrier wall assembly that is disposed between the first nozzle and the second nozzle in the first direction, and includes a plurality of barrier walls that partition a space between the first nozzle and the second nozzle into a plurality of sub-deposition spaces, wherein a distance between the adjacent second slits is different.

According to an aspect of the present invention, the distance between the adjacent second slits may decrease as a distance between a center of each of the sub-deposition spaces and each of the second slits increases.

According to an aspect of the present invention, the distance between the adjacent second slits may decrease as a distance between each of the second slits and each of the first slits arranged in each sub-deposition space increases.

According to an aspect of the present invention, the second slits may be formed to be flocked together to the center of each sub-deposition space.

According to an aspect of the present invention, the second slits may be formed to be further flocked together to the center of each sub-deposition space as the distance between the center of each sub-deposition space and each second slit increases.

According to an aspect of the present invention, each of the barrier walls may extend in a second direction that is substantially perpendicular to the first direction, in order to partition the space between the first nozzle and the second nozzle into the plurality of sub-deposition spaces.

According to an aspect of the present invention, the plurality of barrier walls may be arranged at equal intervals.

According to an aspect of the present invention, the barrier walls may be separated from the second nozzle by a predetermined distance.

According to an aspect of the present invention, the barrier wall assembly may be detachable from the thin film deposition apparatus.

According to an aspect of the present invention, each of the barrier wall assemblies may include a first barrier wall assembly including a plurality of first barrier walls, and a second barrier wall assembly including a plurality of second barrier walls.

According to an aspect of the present invention, each of the first barrier walls and each of the second barrier walls may extend in a second direction that is substantially perpendicular to the first direction, in order to partition the space between the first nozzle and the second nozzle into the plurality of sub-deposition spaces.

According to an aspect of the present invention, the first barrier walls may be arranged to respectively correspond to the second barrier walls.

According to an aspect of the present invention, each pair of the first and second barrier walls corresponding to each other may be arranged on substantially the same plane.

According to an aspect of the present invention, each one of the first slits and the plurality of second slits may be arranged in each sub-deposition space, and the distance between the adjacent second slits may decrease as the distance between each of the second slits and each of the first slits arranged in each sub-deposition space increases.

According to an aspect of the present invention, the second nozzle may be separated a predetermined distance from a target on which a deposition material vaporized in the deposition source is deposited.

According to an aspect of the present invention, the deposition source, the first nozzle, the second nozzle, and the barrier wall assembly may be movable relative to a target on which a deposition material vaporized in the deposition source is deposited, or the target may be movable relative to the deposition source, the first nozzle, the second nozzle, and the barrier wall assembly.

According to an aspect of the present invention, the deposition material may be deposited on the target while the deposition source, the first nozzle, the second nozzle, and the barrier wall assembly are moved relative to the target or while the target is moved relative to the deposition source, the first nozzle, the second nozzle, and the barrier wall assembly.

According to an aspect of the present invention, the deposition source, the first nozzle, the second nozzle, and the barrier wall assembly may be moved relative to the target along a plane parallel to a surface of the target, or the target may be moved relative to the deposition source, the first nozzle, the second nozzle, and the barrier wall assembly along the plane.

According to another aspect of the present invention, there is provided a thin film deposition apparatus for forming a thin film on a target, the apparatus including: a deposition source; a first nozzle that is disposed at a side of the deposition source and includes a plurality of first slits arranged in a first direction; a second nozzle that is disposed opposite to the first nozzle and includes a plurality of second slits arranged in the first direction; and a barrier wall assembly that includes a plurality of barrier walls arranged between the first nozzle and the second nozzle, wherein the second nozzle is separated from the target by a predetermined distance, and a distance between the adjacent second slits is different.

According to an aspect of the present invention, each of the barrier walls may be arranged in the first direction between the first nozzle and the second nozzle, in order to partition the space between the first nozzle and the second nozzle into a plurality of sub-deposition spaces.

According to an aspect of the present invention, the distance between the adjacent second slits may decrease as a distance between a center of each of the sub-deposition spaces and each of the second slits increases.

According to an aspect of the present invention, the distance between the adjacent second slits may decrease as a distance between each of the second slits and each of the first slits arranged in each sub-deposition space increases.

According to an aspect of the present invention, the second slits may be formed to be flocked together to the center of each sub-deposition space.

According to an aspect of the present invention, the second slits may be formed to be further flocked together to the center of each sub-deposition space as the distance between the center of each sub-deposition space and each second slit increases.

According to an aspect of the present invention, the plurality of barrier walls may be arranged at equal intervals.

According to an aspect of the present invention, the barrier walls may be separated from the second nozzle by a predetermined distance.

According to an aspect of the present invention, the barrier wall assembly may be detachable from the thin film deposition apparatus.

According to an aspect of the present invention, each of the barrier wall assemblies may include a first barrier wall assembly including a plurality of first barrier walls, and a second barrier wall assembly including a plurality of second barrier walls.

According to an aspect of the present invention, each of the first barrier walls and each of the second barrier walls may extend in a second direction that is substantially perpendicular to the first direction, in order to partition the space between the first nozzle and the second nozzle into the plurality of sub-deposition spaces.

According to an aspect of the present invention, the first barrier walls may be arranged to respectively correspond to the second barrier walls.

According to an aspect of the present invention, each pair of the first and second barrier walls corresponding to each other may be arranged on substantially the same plane.

According to an aspect of the present invention, one of the first slits and the plurality of second slits may be arranged in each sub-deposition space, and the distance between the adjacent second slits may decrease as the distance between each of the second slits and each of the first slits arranged in each sub-deposition space increases.

According to an aspect of the present invention, the deposition source, the first nozzle, the second nozzle, and the barrier wall assembly may be movable relative to a target on which a deposition material vaporized in the deposition source is deposited, or the target may be movable relative to the deposition source, the first nozzle, the second nozzle, and the barrier wall assembly.

According to an aspect of the present invention, the deposition material may be deposited on the target while the deposition source, the first nozzle, the second nozzle, and the barrier wall assembly are moved relative to the target or while the target is moved relative to the deposition source, the first nozzle, the second nozzle, and the barrier wall assembly.

According to an aspect of the present invention, the deposition source, the first nozzle, the second nozzle, and the barrier wall assembly may be moved relative to the target along a plane parallel to a surface of the target, or the target may be moved relative to the deposition source, the first nozzle, the second nozzle, and the barrier wall assembly along the plane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view of a thin film deposition apparatus according to an embodiment of the present invention;

FIG. 2 is a schematic side view of the thin film deposition apparatus of FIG. 1;

FIG. 3 is a schematic plan view of the thin film deposition apparatus of FIG. 1;

FIG. 4A is a schematic view illustrating deposition of a deposition material in the thin film deposition apparatus of FIG. 1, according to an embodiment of the present invention;

FIG. 4B illustrates a shadow zone of a thin film deposited on a substrate when a deposition space is partitioned by barrier walls, as illustrated in FIG. 5A;

FIG. 4C illustrates a shadow zone of a thin film deposited on the substrate when the deposition space is not partitioned;

FIG. 5A illustrates a plurality of second slits arranged in a second nozzle at equal intervals;

FIG. 5B illustrates a thin film formed on a substrate by using the second nozzle of FIG. 5A;

FIG. 5C is a graph showing the amount of pattern shift according to a distance between a center of a sub-deposition space S and each second slit of the second nozzle of FIG. 5A;

FIG. 6A illustrates a case where the farther away second slits are from a center of the second nozzle of the thin film deposition apparatus of FIG. 1, the less a distance between adjacent second slits, according to an embodiment of the present invention;

FIG. 6B illustrates a thin film formed on a substrate by using the second nozzle of FIG. 6A; and

FIG. 7 is a schematic perspective view of a thin film deposition apparatus according to another embodiment of the present invention.

FIG. 8 is a schematic perspective view of a thin film deposition apparatus according to another embodiment of the present invention;

FIG. 9 is a schematic side view of the thin film deposition apparatus of FIG. 8;

FIG. 10 is a schematic plan view of the thin film deposition apparatus of FIG. 8;

FIG. 11 is a schematic perspective view of the thin film deposition apparatus according to another embodiment of the present invention;

FIG. 12 is a graph schematically illustrating a thickness distribution of a layer formed on a substrate when a deposition source nozzle was not tilted, in a thin film deposition apparatus according to another embodiment of the present invention; and

FIG. 13 is a graph schematically illustrating a thickness distribution of a layer formed on a substrate when a deposition source nozzle was tilted, in a thin film deposition apparatus according to the embodiment of FIG. 12.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

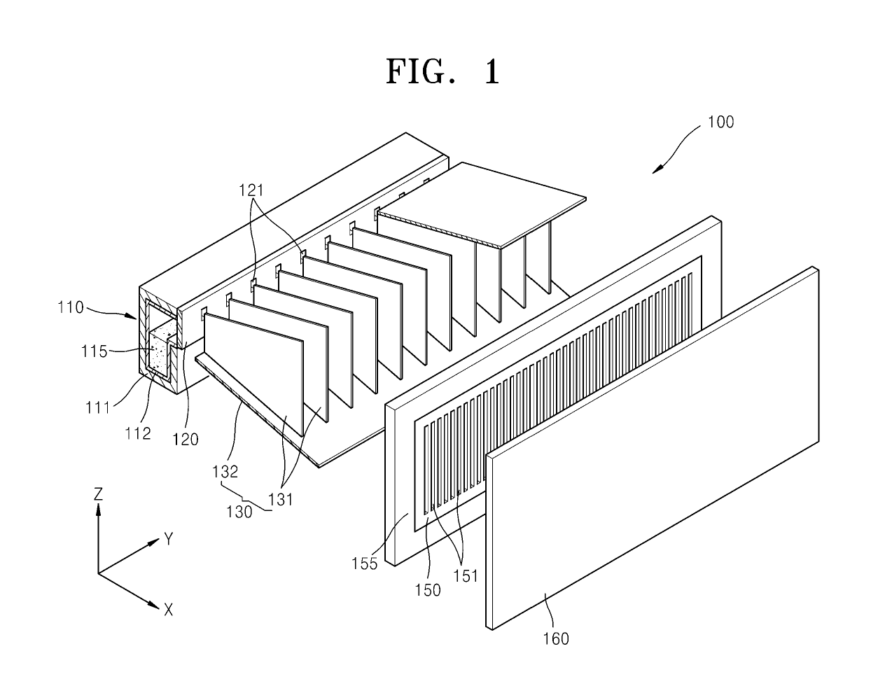

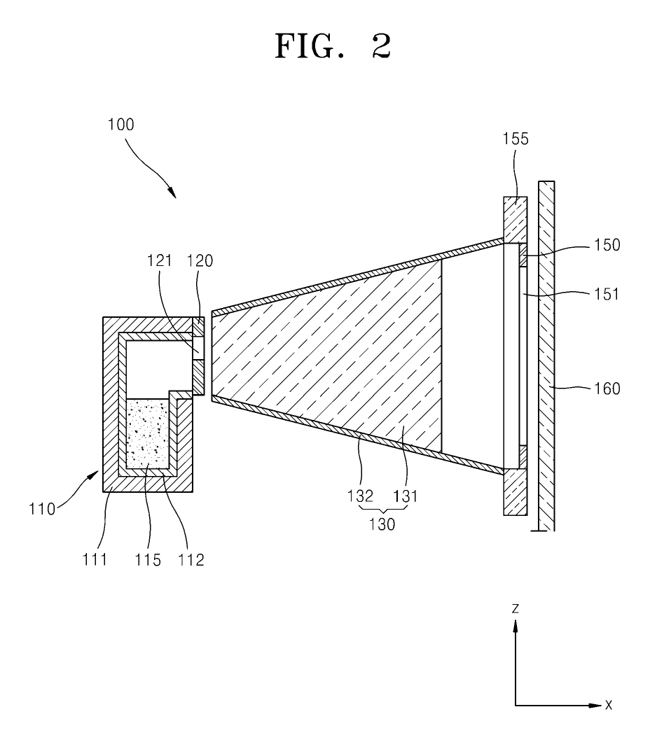

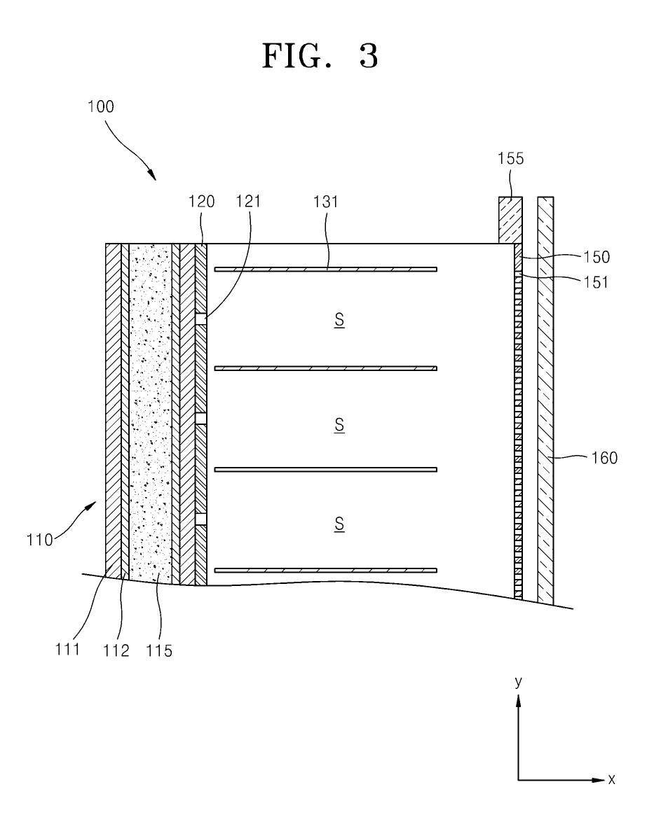

FIG. 1 is a schematic perspective view of a thin film deposition apparatus 100 according to an embodiment of the present invention, FIG. 2 is a schematic side view of the thin film deposition apparatus 100, and FIG. 3 is a schematic plan view of the thin film deposition apparatus 100. Referring to FIGS. 1, 2 and 3, the thin film deposition apparatus 100 includes a deposition source 110, a first nozzle 120, a barrier wall assembly 130, a second nozzle 150, and a second nozzle frame 155.

Although a chamber is not illustrated in FIGS. 1, 2 and 3 for convenience of explanation, all the components of the thin film deposition apparatus 100 may be disposed within a chamber along with the substrate 160 that is maintained at an appropriate degree of vacuum. The chamber is maintained at an appropriate vacuum in order to allow the deposition material 150 to move in a substantially straight line through the thin film deposition apparatus 100 to the substrate 160.

In particular, in order to deposit the deposition material 115 that is discharged from the deposition source 110 on the substrate 160 in a desired pattern, it is required to maintain the chamber in a high-vacuum state as in a deposition method using a fine metal mask (FMM).

In addition, the temperatures of the barrier wall assembly 130 and the second nozzle 150 should be sufficiently lower than the temperature of the deposition source 110. In this regard, the temperatures of the barrier wall assembly 130 and the second nozzle 150 may be about 100° C. or less. This is because the deposition material 115 that has collided against the barrier wall assembly 130 may not be vaporized again when the temperature of the barrier wall assembly 130 is sufficiently low. In addition, the thermal expansion of the second nozzle 150 may be minimized when the temperature of the second nozzle 150 is sufficiently low. The barrier wall assembly 130 faces the deposition source 110 which is at a high temperature. In addition, the temperature of a portion of the first barrier wall assembly 130 close to the deposition source 110 rises by a maximum of about 167° C., and thus a partial-cooling apparatus may be further included if needed. To this end, the barrier wall assembly 130 may include a cooling member.

The deposition material 115 is deposited on the substrate 160. The substrate 160 is disposed in the chamber. The substrate 160 may be a substrate for flat panel displays. A large substrate, such as a mother glass, for manufacturing a plurality of flat panel displays, may be used as the substrate 160. Other substrates may also be employed.

The deposition source 110 contains and heats the deposition material 115. The deposition source 110 is disposed on a side of the chamber opposite to the side in which the substrate 160 is disposed. As the deposition material 115 contained in the deposition source 110 is vaporized, the deposition material 115 is deposited on the substrate 160 after passing through the first nozzle 120, the barrier wall assembly 130, and the second nozzle 150. The deposition source 110 includes a crucible 111 and a heater 112. The crucible 111 holds the deposition material 115. The heater 112 heats the crucible 111 to vaporize the deposition material 115 contained in the crucible 111, towards a side of the crucible 111, and in particular, towards the first nozzle 120.

The first nozzle 120 is disposed at a side of the deposition source 110 facing the substrate 160. The first nozzle 120 includes a plurality of first slits 121 arranged at equal intervals in a Y-axis direction. The deposition material 115 that is vaporized in the deposition source 110, passes through the first nozzle 120 and proceeds towards the substrate 160.

The barrier wall assembly 130 is disposed at a side of the first nozzle 120 so as to be between the first nozzle 120 and the second nozzle 150. The barrier wall assembly 130 includes a plurality of barrier walls 131, and a barrier wall frame 132 that constitutes an outer wall of the barrier walls 131. The plurality of barrier walls 131 are arranged parallel to each other at equal intervals in Y-axis direction. In addition, each of the barrier walls 131 is arranged parallel to an XZ plane in FIG. 1, (i.e., perpendicular to the Y-axis direction). The barrier walls 131 arranged as described above partition the space between the first nozzle 120 and the second nozzle 150, which is to be described later, into a plurality of sub-deposition spaces S. However, the invention is not limited to a particular orientation of the barrier walls 131.

In the thin film deposition apparatus 100 according to the current embodiment of the present invention, the deposition space S is divided by the barrier walls plates 131 into the sub-deposition spaces S that respectively correspond to the first slits 121 through which the deposition material 115 is discharged. While not limited thereto, the shown barrier walls 131 are respectively disposed between adjacent first slits 121. Each of the first slits 121 is disposed between two adjacent barrier walls 131. The first slits 121 may be respectively located at the midpoint between two adjacent barrier walls 131. As described above, since the barrier walls 131 partition the space between the first nozzle 120 and the second nozzle 150, the deposition material 115 discharged through one of the first slits 121 is not mixed with the deposition material 115 discharged through another first slits 121. The deposition material 115 then passes through second slits 151 so as to be deposited on the substrate 160. The barrier walls 131 guide the deposition material 115, which is discharged through the first slits 121, so as not to flow in the Y-axis direction.

The barrier wall frame 132 forms upper and lower sides of the barrier walls 131. The barrier wall frame 132 retains the positions of the barrier walls 131, and guides the deposition material 115, which is discharged through the first slits 121, so as not to flow in a Z-axis direction.

While not required in all aspects, the barrier wall assembly 130 is detachable from the thin film deposition apparatus 100. A conventional FMM deposition method has low deposition efficiency. Herein, deposition efficiency refers to the ratio of a deposition material deposited on a substrate to the deposition material vaporized from a deposition source. The conventional FMM deposition method has a deposition efficiency of about 32%. Furthermore, in the conventional FMM deposition method, about 68% of organic deposition material that is not been deposited on the substrate remains adhered to a deposition apparatus, and thus reusing the deposition material is not straightforward.

In order to overcome these problems, the thin film deposition apparatus 100 has enclosed the deposition space within the barrier wall assembly 130. The deposition material 115 that remains undeposited is mostly deposited within the barrier wall assembly 130. Thus, when a large amount of the deposition material 115 lies in the barrier wall assembly 130 after a long deposition process, the barrier wall assembly 130 may be detached from the thin film deposition apparatus 100 and then placed in a separate deposition material recycling apparatus to recover the deposition material 115. Due to the structure of the thin film deposition apparatus 100 according to the present embodiment, a reuse rate of the deposition material 115 is increased, so that the deposition efficiency is improved, whereas the manufacturing costs are reduced.

The second nozzle 150 and the second nozzle frame 155 are disposed between the deposition source 110 and the substrate 160. While not required in all aspects, the shown second nozzle frame 155 is formed in a lattice shape, similar to a window frame. The second nozzle 150 is bound inside the second nozzle frame 155. The second nozzle 150 includes a plurality of second slits 151 arranged at equal intervals in the Y-axis direction, each second slit 151 being elongated in the Z-axis direction. The deposition material 115 that is vaporized in the deposition source 110, passes through the first nozzle 120 and the second nozzle 150 towards the substrate 160.

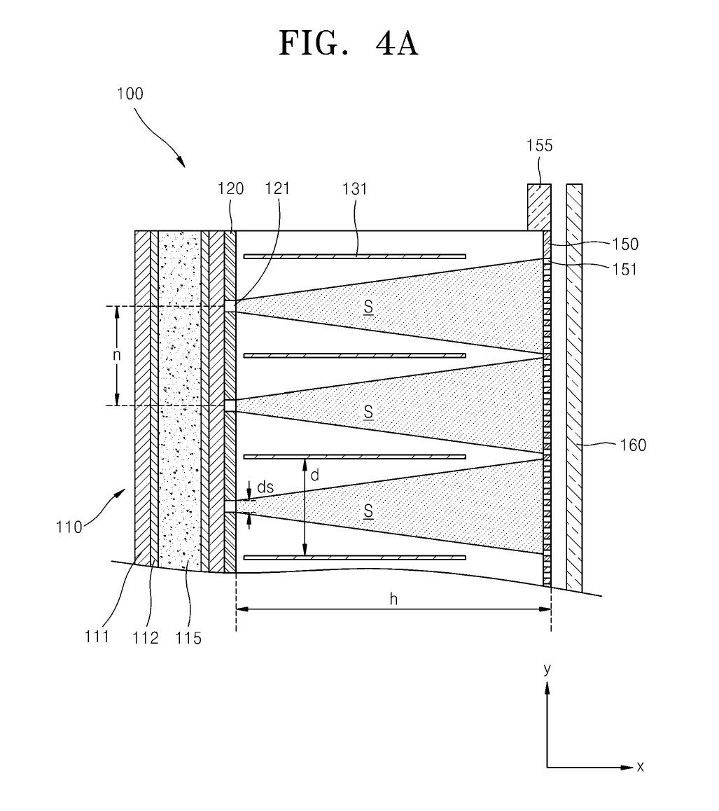

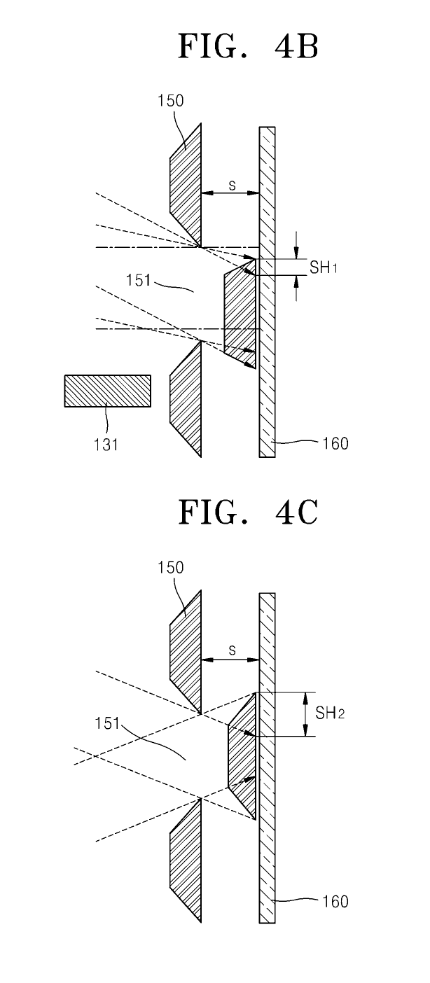

In the thin film deposition apparatus 100, the second nozzle 150 is formed so that a distance between the second slits 151 of the second nozzle 150 is not uniform. In particular, that the distance decreases the farther away the second slits 151 are from the center of the second nozzle 150 where no barrier wall assembly 130 is used, or from a midpoint between barrier walls 131 where the barrier wall assembly 130 is used. The structure of the second nozzle 150 will be described in detail with reference to FIGS. 4A through 4C.

In the thin film deposition apparatus 100 according to the current embodiment of the present invention, the total number of second slits 151 is greater than the total number of first slits 121. In addition, there may be a greater number of second slits 151 than first slits 121 disposed between two adjacent barrier walls 131. However, the relationship in the number of second slits 151, first slits 121, and barrier walls 131 is not particularly limited.

As shown, at least one first slit 121 is disposed between each two adjacent barrier walls 131. A plurality of the second slits 151 is also disposed between each two adjacent barrier walls 131. The space between the first nozzle 120 and the second nozzle 150 is partitioned by the barrier walls 131 into sub-deposition spaces S that correspond to the first slits 121, respectively. Thus, the deposition material 115 discharged from each of the first slits 121 passes through a plurality of second slits 151 disposed in the sub-deposition space S corresponding to the first slit 121, and is then deposited on the substrate 160.

The second nozzle 150 may be manufactured by etching, which is the same method as used in a conventional method of manufacturing an FMM, and in particular, a striped FMM. In the conventional FMM deposition method, the size of the FMM has to be equal to the size of a substrate. Thus, the size of the FMM has to be increased as the substrate becomes larger. However, it is neither straightforward to manufacture a large FMM nor to extend an FMM to be accurately aligned with a pattern.

However, in the thin film deposition apparatus 100 according to the current embodiment of the present invention, a thin film is deposited while the thin film deposition apparatus 100 is moved in the Z-axis direction within the chamber (not shown). In other words, once the thin film deposition apparatus 100 has completed deposition at a current location, either the thin film deposition apparatus 100 or the substrate 160 is moved relative to each other in the Z-axis direction for further continuous deposition. Thus, in the thin film deposition apparatus 100 according to the current embodiment of the present invention, the second nozzle 150 may be significantly smaller than a FMM used in a conventional deposition method.

In other words, in the thin film deposition apparatus 100 according to the current embodiment of the present invention, the length of the second nozzle 150 in the Z-axis direction may be less than the length of the substrate 160 in the Z-axis direction, provided that the width of the second nozzle 150 in the Y-axis direction is greater than or equal to the width of the substrate 160 in the Y-axis direction. As described above, since the second nozzle 150 may be formed to be significantly smaller than a FMM used in a conventional deposition method, it is relatively easy to manufacture the second nozzle 150 used in the present invention. In other words, using the second nozzle 150, which is smaller than a FMM used in a conventional deposition method, is more convenient in all processes, including etching and subsequent other processes, such as precise extension, welding, moving, and cleaning processes, compared to the conventional deposition method using the larger FMM. This is more advantageous for a relatively large display device. However, the method of forming the second nozzle 150 is not particularly limited.

The barrier wall assembly 130 and the second nozzle 150 are separated from each other by a predetermined distance. The barrier wall assembly 130 and the second nozzle 150 are separated from each other for the following reasons. The second nozzle 150 and the second nozzle frame 155 should be aligned with the substrate 160 to be accurate in position and to have a constant interval therebetween, and thus require high-precision control. Thus, in order to make it easy to control such parts that require high-precision control, the second nozzle 150 and the second nozzle frame 155 are separated from the deposition source 110, the first nozzle 120 and the barrier wall assembly 130, which are relatively heavy parts not requiring precise control. The temperature of the barrier wall assembly 130 may increase to 100° C. or higher due to the deposition source 110 whose temperature is high. Thus, in order to prevent the heat of the barrier wall assembly 130 from being conducted to the second nozzle 150, the barrier wall assembly 130 and the second nozzle 150 are separated from each other. In the thin film deposition apparatus 100 according to the current embodiment of the present invention, the deposition material 115 adhered to the barrier wall assembly 130 is mostly reused, whereas the deposition material 115 adhered to the second nozzle 150 may not be reused. Thus, when the barrier wall assembly 130 is separated from the second nozzle 150, it may be straightforward to recover the deposition material 115 to be reused. In addition, a calibration plate (not shown) may be further installed in order to ensure uniformity of a thin film over the entire substrate 160. When the barrier walls 131 are separated from the second nozzle 150, it is very straightforward to install the calibration plate. Finally, a partition (not shown) may be further installed in order to prevent deposition of the deposition material 115 on the second nozzle 150 after deposition onto the substrate 160 has been completed and before another target is subjected to deposition. This may extend a nozzle exchange cycle. It is straightforward to install the partition between the barrier walls 131 and the second nozzle 150. It is understood that other reasons can exist for the predetermined distance, and that the predetermined distance can be zero in other aspects of the invention.

FIG. 4A is a schematic view illustrating deposition of the deposition material 115 in the thin film deposition apparatus 100, according to an embodiment of the present invention. FIG. 4B illustrates a shadow zone of a thin film deposited on the substrate 160 when the deposition space is partitioned by the barrier walls 131. FIG. 4C illustrates a shadow zone of a thin film deposited on the substrate 160 when the deposition space is not partitioned.

Referring to FIG. 4A, the deposition material 115 that is vaporized in the deposition source 110 is deposited on the substrate 160 by being discharged through the first nozzle 120 and the second nozzle 150. Since the space between the first nozzle 120 and the second nozzle 150 is partitioned into a plurality of sub-deposition spaces S by the barrier walls 131, the deposition material 115 discharged through each of the first slits 121 of the first nozzle 120 is not mixed with the deposition material 115 discharged through the other first slits 121 due to the barrier walls 131.

When the space between the first nozzle unit 120 and the second nozzle 150 is partitioned by the barrier wall assembly 130, as illustrated in FIGS. 4A and 4B, a width SH₁ of a shadow zone formed on the substrate 160 may be determined according to Equation 1 below.

SH₁=s*dₛ/h Equation 1

where s denotes a distance between the second nozzle 150 and the substrate 160, dₛ denotes a width of the first slits 121 close to the deposition source 110, and h denotes a distance between the deposition source 110 and the second nozzle 150.

However, when the space between the first nozzle 120 and the second nozzle 150 is not partitioned by the barrier walls 131, as illustrated in FIG. 4C, the deposition material 115 is discharged through the second nozzle 150 in a wider range of angles than in the case of FIG. 4B. This is because the deposition material 115 discharged not just through a first slit 121 directly facing a second slit 151 but also through first slits 121 other than the first slit 121 above, passes through the second slit 151 above and is then deposited on the substrate 160. Thus, a width SH₂ of a shadow zone formed on the substrate 160 is much greater than when the deposition space is partitioned by the barrier walls 131. The width SH₂ of the shadow zone formed on the substrate 160 is determined according to Equation 2.

SH₂=s*2n/h Equation 2

where s denotes a distance between the second nozzle 150 and the substrate 160, n denotes an interval between adjacent first slits, and h denotes a distance between the deposition source 110 and the second nozzle 150.

Referring to Equations 1 and 2, dₛ, which is the width of the first slits 121, is up to ten or more times smaller than n, which is the interval between the adjacent first slits 121, and thus, the shadow zone may have a smaller width when the space between the first nozzle 120 and the second nozzle 150 is partitioned by the barrier walls 131. The width SH₁ of the shadow zone formed on the substrate 160 may be reduced by adjusting any of the following factors: reducing the interval d between the adjacent barrier walls 131; by reducing the distance s between the second nozzle 150 and the substrate 160, or by increasing the distance h between the deposition source 110 and the second nozzle 150.

As described above, the shadow zone formed on the substrate 160 may be reduced by installing the barrier walls 131. Thus, the second nozzle 150 can be separated from the substrate 160.

In the thin film deposition apparatus 100 according to the current embodiment of the present invention, the second nozzle 150 may be separated from the substrate 160 by a predetermined distance. In other words, in a conventional deposition method using a FMM, deposition is performed with the FMM in close contact with a substrate in order to prevent formation of a shadow zone on the substrate. However, when the FMM is used in close contact with the substrate, the contact may cause defects. In addition, in the conventional deposition method, the size of the mask has to be the same as the size of the substrate since the mask cannot be moved relative to the substrate. Thus, the size of the mask has to be increased as display devices become larger. However, it is not easy to manufacture such a large mask.

In order to overcome this problem, in the thin film deposition apparatus 100 according to the current embodiment of the present invention, the second nozzle 150 is disposed to be separated from the substrate 160 by a predetermined distance. This may be implemented by installing the barrier walls 131 to reduce the width of the shadow zone formed on the substrate 160. However, it is understood other mechanisms can be used in addition to or instead of the barrier wall assembly 130.

As described above, according to the present invention, a mask is formed to be smaller than the substrate 160, and deposition is performed while the mask is moved relative to the substrate. Thus, the mask can be easily manufactured. In addition, a defect caused due to the contact between a substrate and a FMM, which occurs in the conventional deposition method, may be prevented. In addition, since it is unnecessary to use the FMM in close contact with the substrate during a deposition process, the manufacturing speed may be improved.

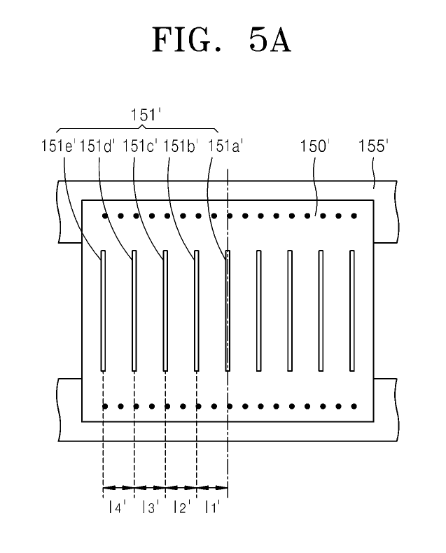

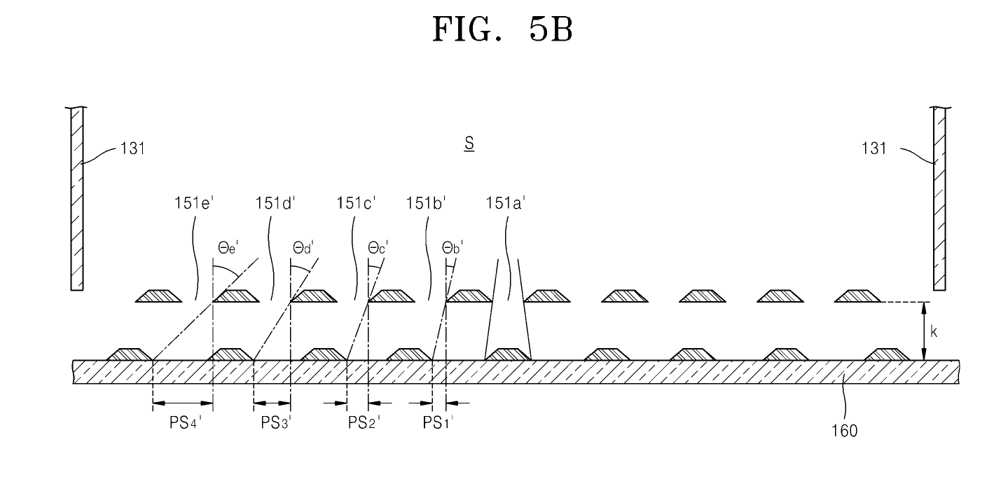

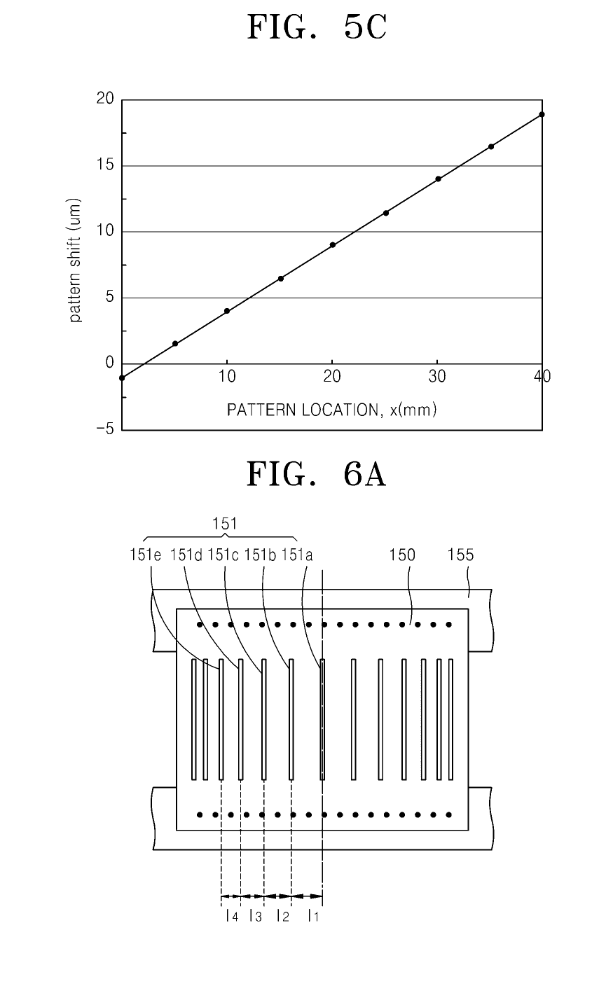

Hereinafter, the structure of second slits of a second nozzle will be described in detail. In relation to FIGS. 5A through 5C, FIG. 5A illustrates a plurality of slits 151′ arranged in a second nozzle 150′ at equal intervals, and FIG. 5B illustrates a thin film formed on a substrate 160 by using the second nozzle 150′ of FIG. 5A. FIG. 5C is a graph showing the amount of pattern shift according to a distance between a center of one of the sub-deposition spaces S and each second slit 151′. FIGS. 5A and 5B illustrate only a portion of the second nozzle 150′ arranged between two adjacent barrier walls 131. In this regard, the second slits 151′ in the portion of the second nozzle 150′ arranged between two adjacent barrier walls 131 include second slits 151a′, 151b′, 151c′, 151d′, and 151e′, arranged in one sub-deposition space S.

Referring to FIGS. 5A and 5B, the second slits 151′ are arranged at equal intervals. In other words, in FIG. 5A, an interval I₁′ between the second slits 151a′ and 151b′, an interval I₂′ between the second slits 151b′ and 151c′, an interval I₃′ between the second slits 151c′ and 151d′, and an interval I₄′ between the second slits 151d′ and 151e′ are all the same ′. In this case, an angle formed by a deposition material 115 discharged through the second slit 151a′ disposed under first slits (not shown) is nearly perpendicular to the substrate 160. Thus, a thin film formed from the deposition material discharged through the second slit 151a′ is located at the midpoint of the second nozzle 150′.

However, a threshold angle θ formed by the deposition material 115 discharged through the second slits 151′ disposed to be far away from the corresponding first slit (not shown) of the sub-deposition space S is gradually increased so that the threshold angle θ formed by the deposition material 115 discharged through the second slit 151e′ disposed at an end of the second nozzle 150′ may be about 55°. Thus, the deposition material 115 is discharged through the second slit 151e′ at an oblique angle, and the thin film formed from the deposition material discharged 115 through the second slit 151e′ is slightly shifted to the left of the second slit 151e′.

In this case, the amount of shift of the deposition material is determined according to Equation 3 below.

Max pattern shift=k*tan θ=k*(2x−dₛ)/2h Equation 3

where k denotes a distance between the second nozzle 150′ and the substrate 160, θ denotes a threshold angle formed by the deposition material 115, x denotes a distance between a center of the sub-deposition space S and each second slit 151′, dₛ denotes a width of the first slit 121 close to the deposition source 110, and h denotes a distance between the deposition source 110 and the second nozzle 150.

In other words, as the threshold angle θ formed by the deposition material 115 discharged through the second slits 151′ is increased, the amount of pattern shift is increased. The threshold angle θ formed by the deposition material discharged through the second slits 151′ is increased as a distance between the center of the sub-deposition space S and the second slits 151′ increases. Thus, as the distance between the center of the sub-deposition space S and the second slits 151′ increases, the amount of pattern shift is increased. The relationship between the distance between the center of the sub-deposition space S and the second slits 151′ and the amount of pattern shift is shown in FIG. 5C. Here, it is assumed that the distance k between the second nozzle 150′ and the substrate 160, the width dₛ of the first slit 121 close to the deposition source 110 and the distance h between the deposition source 110 and the second nozzle 150′ are uniform.

Referring to Equation 3 and FIG. 5B, the deposition material is discharged through the second slit 151b′ at a threshold angle θ_{b}′. In this case, the thin film formed by using the deposition material discharged through the second slit 151b′ is shifted to the left by PS₁′. Similarly, the deposition material is discharged through the second slit 151c′ at a threshold angle θ_{c}′. In this case, the thin film formed by using the deposition material discharged through the second slit 151c′ is shifted to the left by PS₂′. Similarly, the deposition material is discharged through the second slit 151d′ at a threshold angle θ_{d}′. In this case, the thin film formed by using the deposition material discharged through the second slit 151d′ is shifted to the left by PS₃′. Last, the deposition material is discharged through the second slit 151e′ at a threshold angle θₑ′. In this case, the thin film formed by using the deposition material discharged through the second slit 151e′ is shifted to the left by PS₄′.

Since θ_{b}′<θ_{c}′<θ_{d}′<θₑ′, PS₁′<PS₂′<PS₃′<PS₄′ is satisfied between the amount of shift of patterns, i.e., the deposition materials, discharged through the second slits 151′. In this way, when the second slits 151′ are arranged in the second nozzle 150′ at equal intervals, the amount of shift of the patterns formed through the second slits 151′ is increased as the distance between the center of the sub-deposition space S and the second slits 151′ is increased, so that a difference in pattern locations may be gradually increased.

In order to overcome this problem, in the thin film deposition apparatus 100 according to the current embodiment of the present invention, the farther away the second slits 151′ are from a center of the sub-deposition space S of second nozzle 150′, the less the distance between adjacent second slits 151′.

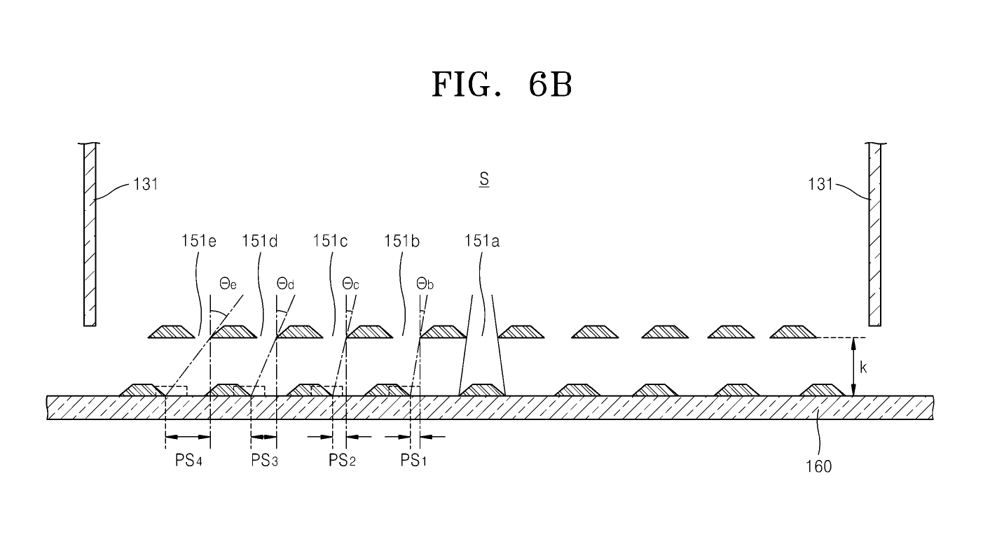

FIG. 6A illustrates a case where the farther away second slits 151 are from a center of the second nozzle 150, the less a distance between the adjacent second slits 151 of the second nozzle 150, according to another embodiment of present invention. FIG. 6B illustrates a thin film formed on the substrate 160 by using the second nozzle 150 of FIG. 6A. FIGS. 6A and 6B illustrate only a portion of the second nozzle 150 disposed between two adjacent barrier walls 131. In this regard, the second slits 151 in the portion of the second nozzle 150 arranged between two adjacent barrier walls 131 include second slits 151a, 151b, 151c, 151d, and 151e, arranged in one sub-deposition space S.

In FIGS. 6A and 6B, a distance between the second slits 151 decreases the farther away the second slits 151 are from the center of the sub-deposition space S of the second nozzle 150. In other words, in FIG. 6A, I₁>I₂>I₃>I₄. More specifically, an interval I₂ between the second slit 151b and the second slit 151c is less than an interval I₁ between the second slit 151a and the second slit 151b, an interval I₃ between the second slit 151c and the second slit 151d is less than the interval I₂ between the second slit 151b and the second slit 151c, and an interval I₄ between the second slit 151d and the second slit 151e is less than the interval I₃ between the second slit 151c and the second slit 151d.

The reason why the distance between adjacent second slits 151 decreases the farther away the second slits 151 are from the center of the second nozzle 150 is that the amount of pattern shift is increased as the distance between the center of a sub-deposition space S and the second slits 151 increases, as described previously with reference to FIGS. 5A and 5C. In order to correct the amount of pattern shift that is increased as the distance between the center of the sub-deposition space S and the second slits 151 increases, the distance between the adjacent second slits 151 is reduced the farther away the second slits 151 are from the center of the second nozzle 150.

Here, the interval I₁ between the second slit 151a and the second slit 151b shown in FIG. 6A is less than the interval I₁′ between the second slit 151a′ and the second slit 151b′ shown in FIG. 5A (I₁′>I₁). Also, the interval I₂ between the second slit 151b and the second slit 151c in FIG. 6A is less than the interval 1₂′ between the second slit 151b′ and the second slit 151c′ in FIG. 5A (I₂′>I₂). Also, the interval 1₃ between the second slit 151c and the second slit 151d in FIG. 6A is less than the interval I₃′ between the second slit 151c′ and the second slit 151d′ in FIG. 5A (I₃′>I₃). Also, the interval 1₄ between the second slit 151d and the second slit 151e in FIG. 6A is less than the interval 1₄′ between the second slit 151d′ and the second slit 151e′ in FIG. 5A (I₄′>I₄). However, it is understood that one of the distances could be larger than where the second slits are spaced equally as in FIG. 5A.

Equations that represent the relationship between the distance between the second slits 151′ in FIG. 5A and the distance between the second slits 151 in FIG. 6A will be satisfied only when a distance x between the center of the sub-deposition space S and each second slit 151 or 151′ is greater than the width dₛ of each of the first slits 121 close to the deposition source 110. This is because, as shown in FIG. 5C, the amount of pattern shift is slightly decreased to a small negative value when x=0, and when x<dₛ, pattern shift is performed in an opposite direction to the direction in which pattern shift is performed when x=0.

In contrast to the case when the second slits 151′ are arranged in the second nozzle 150′ at equal intervals as shown in FIGS. 5A and 5B, all of the second slits 151 are slightly moved to the center of the second nozzle 150, and a distance between the adjacent second slits 151 decreases the farther away the second slits 151 are from the center of the second nozzle 150. As a result, the whole amount of pattern shift is reduced. In other words, a first pattern shift amount PS₁ in FIG. 6A is less than a first pattern shift amount PS₁′ in FIG. 5A (PS₁′>PS₁), a second pattern shift amount PS₂ in FIG. 6A is less than a second pattern shift amount PS₂′ in FIG. 5A (PS₂′>PS₂), a third pattern shift amount PS₃ in FIG. 6A is less than a third pattern shift amount PS₃′ in FIG. 5A (PS₃′>PS₃), and a fourth pattern shift amount PS₄ in FIG. 6A is less than a fourth pattern shift amount PS₄′ in FIG. 5A (PS₄′>PS₄).

In this way, a pattern shift phenomenon may be prevented the amount of pattern shift is reduced, and patterns may be precisely formed at equal intervals so that the performance and reliability of the thin film deposition apparatus 100 may be improved.

Although the second slits 151 are arranged in one sub-deposition space S, aspects of the present invention are not limited thereto. The second nozzle 150 having the shape of FIG. 6A may be repeatedly disposed in each sub-deposition space S.

Although the barrier walls 131 are arranged at equal intervals, aspects of the present invention are not limited thereto. The barrier walls 131 may be arranged at different intervals so that a width of each sub-deposition space S may be different. In this case, the amount of shift of patterns formed by discharging deposition material through the second slits 151 in each sub-deposition space S may be different. Moreover, while shown using the barrier wall assembly 130, it is understood that aspects of the invention can be implemented where not barrier wall assembly 130 is used.

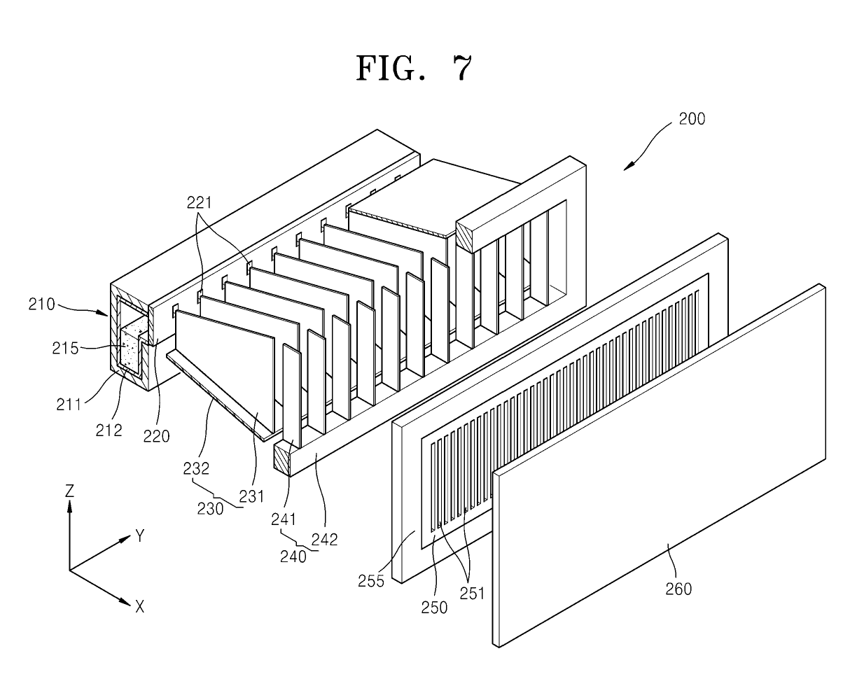

FIG. 7 is a schematic perspective view of a thin film deposition apparatus 200 according to another embodiment of the present invention. Referring to FIG. 7, the thin film deposition apparatus 200 includes a deposition source 210, a first nozzle 220, a first barrier wall assembly 230, a second barrier wall assembly 240, a second nozzle 250, a second nozzle frame 255, and a substrate 260.

Although a chamber is not illustrated in FIG. 7 for convenience of explanation, all the components of the thin film deposition apparatus 200 may be disposed within a chamber along with the substrate 260 that is maintained at an appropriate degree of vacuum. The chamber is maintained at an appropriate vacuum in order to allow a deposition material to move in a substantially straight line through the thin film deposition apparatus 200.

The substrate 260, on which a deposition material 215 is to be deposited, is disposed in the chamber. The deposition source 210 contains and heats the deposition material 215. The deposition source 210 is disposed on a side of the chamber that is opposite to a side on which the substrate 260 is disposed. The deposition source 210 may include a crucible 211 and a heater 212 as shown.

The first nozzle 220 is disposed at a side of the deposition source 210, and in particular, at the side of the deposition source 210 facing the substrate 260. The first nozzle 220 includes a plurality of first slits 221 arranged at equal intervals in a Y-axis direction.

The first barrier wall assembly 230 is disposed at a side of the first nozzle 220. The first barrier wall assembly 230 includes a plurality of first barrier walls 231, and a first barrier wall frame 231 that constitutes an outer wall of the first barrier walls 232.

The second barrier wall assembly 240 is disposed at a side of the first barrier wall assembly 230 such that the second barrier wall assembly 240 is between the first barrier wall assembly 230 and the second nozzle 250. The second barrier wall assembly 240 includes a plurality of second barrier walls 241, and a second barrier wall frame 241 that constitutes an outer wall of the second barrier walls 242.

The second nozzle 250 and the second nozzle frame 255 are disposed between the second barrier wall assembly 240 and the substrate 260. The second nozzle frame 255 may be formed in a lattice shape, similar to a window frame. The second nozzle 250 is bound inside the second nozzle frame 155. The second nozzle 250 includes a plurality of second slits 251 arranged at equal intervals in the Y-axis direction.

The thin film deposition assembly 200 according to the current embodiment of the present invention includes two separate barrier plate assemblies, (i.e., the first barrier plate assembly 230 and the second barrier plate assembly 240), unlike the thin film deposition assembly 100 illustrated in FIG. 1, which includes one barrier wall assembly 130. However, it is understood that more than two barrier wall assemblies can be used in other aspects.

The plurality of first barrier walls 231 may be arranged parallel to each other at equal intervals in the Y-axis direction. In addition, each of the first barrier walls 231 may be formed to extend along an XZ plane in FIG. 7 (i.e., perpendicular to the Y-axis direction). However, the invention is not limited to a particular orientation of the barrier walls 231.

The second barrier walls 241 are shown arranged parallel to each other at equal intervals in the Y-axis direction. In addition, each of the first barrier walls 241 is shown formed to extend along an XZ plane in FIG. 7 (i.e., perpendicular to the Y-axis direction). However, the invention is not limited to a particular orientation of the barrier walls 241.

The plurality of first barrier walls 231 and the plurality of second barrier walls 241 arranged as described above partition the space between the first nozzle 220 and the second nozzle 250. In the thin film deposition apparatus 200, the deposition space is divided by the first barrier walls 231 and the second barrier walls 241 into sub-deposition spaces that respectively correspond to the first slits 221 through which the deposition material 215 is discharged.

The second barrier walls 241 may be disposed to correspond respectively to the first barrier walls 231. Specifically, the shown second barrier walls 241 are respectively disposed to be parallel to and to be on the same plane as the first barrier walls 231. Each pair of the corresponding first and second barrier walls 231 and 241 may be located on the same plane as shown, but the invention is not limited thereto. As described above, since the space between the first nozzle 220 and the second nozzle 250 is partitioned by the first barrier walls 231 and the second barrier walls 241, the deposition material 215 discharged through one of the first slits 221 is not mixed with the deposition material 215 discharged through the other first slits 221, and is deposited on the substrate 260 through the second slits 251. Thus, the first barrier walls 231 and the second barrier walls 241 guide the deposition material 215, which is discharged through the first slits 221, so as not to flow in the Y-axis direction.

Although the first barrier walls 231 and the second barrier walls 241 are respectively illustrated as having the same thickness in the Y-axis direction, aspects of the present invention are not limited thereto. For instance, the second barrier walls 241, which need to be accurately aligned with the second nozzle 250, may be formed to be relatively thin. In contrast, the first barrier walls 231, which do not need to be precisely aligned with the second nozzle 250, may be formed to be relatively thick. This makes it easier to manufacture the thin film deposition apparatus 200.

Although not illustrated, in the thin film deposition apparatus 200 according to the current embodiment of the present invention, a distance between the adjacent second slits 251 becomes smaller as the second slits 251 are arranged to be farther away from a center of the second nozzle 250. In contrast to the case when the second slits 251 are arranged in the second nozzle 250 at equal intervals as shown, all of the second slits 251 are slightly moved to the center of the second nozzle 250, and the distance between the adjacent second slits 251 is made smaller as the second slits 251 are arranged to be farther away from the center of the second nozzle 250. As a result, the whole amount of pattern shift is reduced. Since the second slits 251 of the second nozzle 250 have been described in detail in the previous embodiment as shown in FIGS. 6A and 6B, a detailed description thereof will not be provided here.

As described above, the thin film deposition apparatus according to aspects of the present invention may be easily manufactured and may be simply applied to manufacture large-sized display devices on a mass scale. The thin film deposition apparatus may improve manufacturing yield and deposition efficiency and may allow deposition materials to be reused. In addition, a distance between patterns formed by discharging deposition material through second slits of a second nozzle is uniform so that the reliability of the thin film deposition apparatus may be improved.

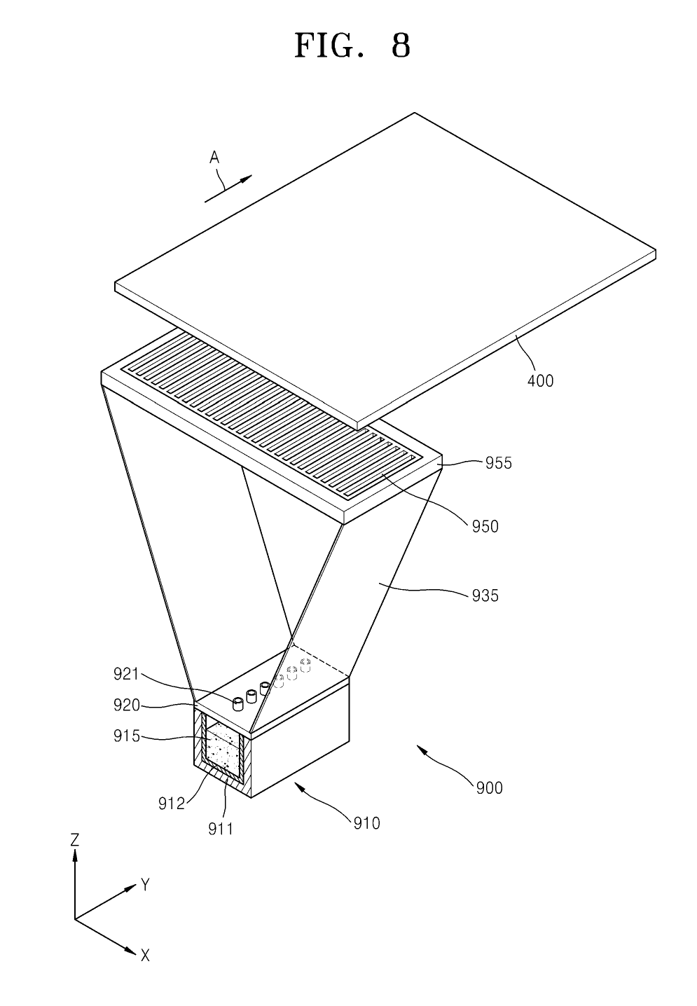

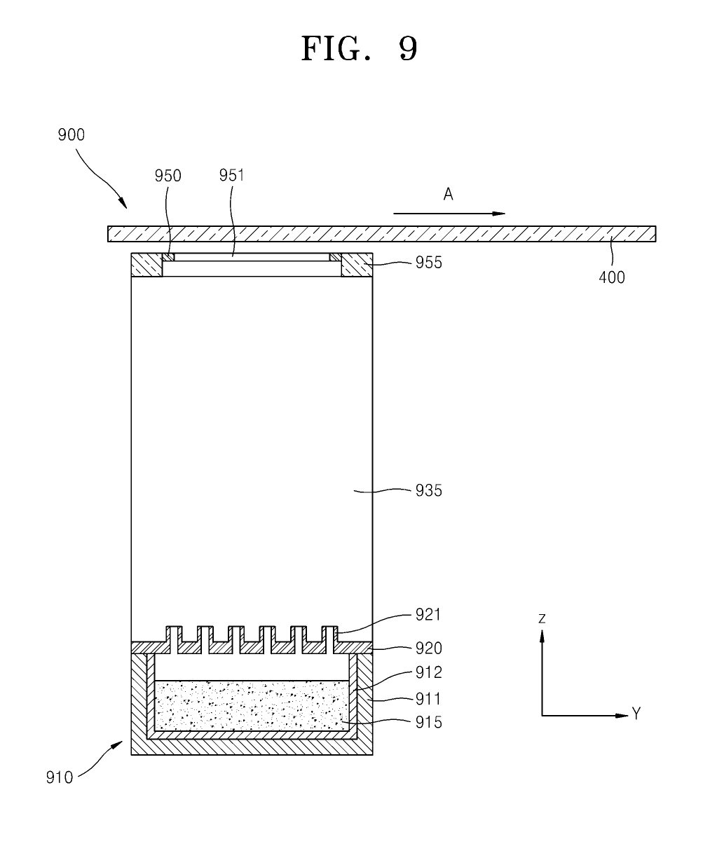

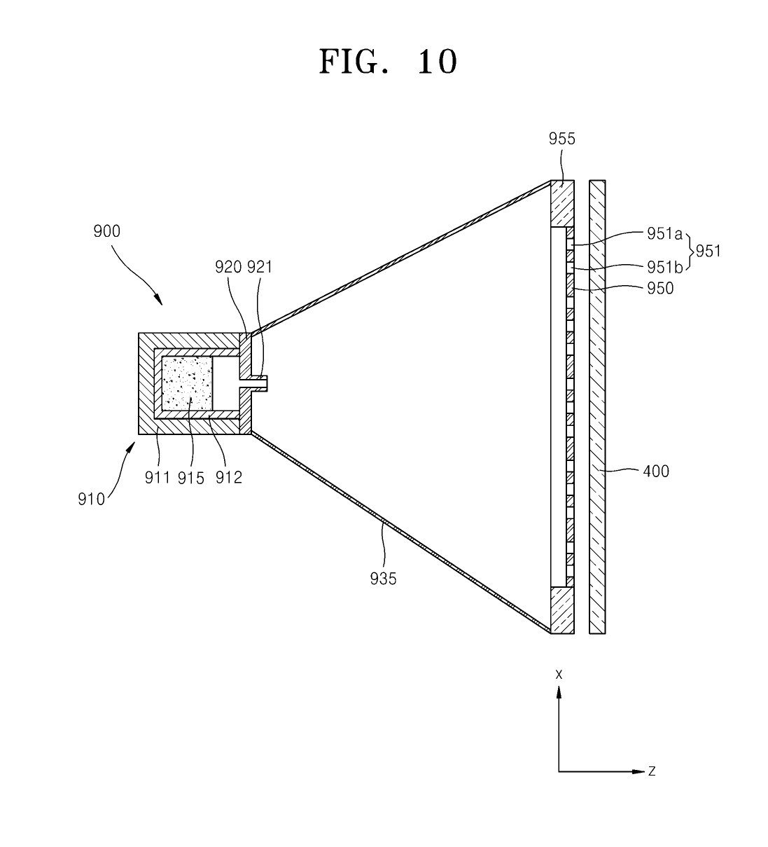

FIG. 8 is a schematic perspective view of a thin film deposition apparatus 900 according to another embodiment of the present invention, FIG. 9 is a schematic side view of the thin film deposition apparatus 900, and FIG. 10 is a schematic plan view of the thin film deposition apparatus 900.

Referring to FIGS. 8, 9 and 10, the thin film deposition apparatus 900 according to the current embodiment of the present invention includes a deposition source 910, a deposition source nozzle unit 920, and a patterning slit sheet 950. Although a chamber is not illustrated in FIGS. 8, 9 and 10 for convenience of explanation, all the components of the thin film deposition assembly 900 may be disposed within a chamber that is maintained at an appropriate degree of vacuum. The chamber is maintained at an appropriate vacuum in order to allow a deposition material to move in a substantially straight line through the thin film deposition apparatus 900.

In particular, in order to deposit a deposition material 915 that is emitted from the deposition source 910 and is discharged through the deposition source nozzle unit 920 and the patterning slit sheet 950, onto a substrate 400 in a desired pattern, it is required to maintain the chamber in a high-vacuum state as in a deposition method using a fine metal mask (FMM). In addition, the temperature of the patterning slit sheet 950 has to be sufficiently lower than the temperature of the deposition source 910. In this regard, the temperature of the patterning slit sheet 950 may be about 100° C. or less. The temperature of the patterning slit sheet 950 should be sufficiently low so as to reduce thermal expansion of the patterning slit sheet 950.

The substrate 400, which constitutes a target on which a deposition material 915 is to be deposited, is disposed in the chamber. The substrate 400 may be a substrate for flat panel displays. A large substrate, such as a mother glass, for manufacturing a plurality of flat panel displays, may be used as the substrate 400. Other substrates may also be employed.

In the current embodiment of the present invention, deposition may be performed while the substrate 400 or the thin film deposition assembly 900 is moved relative to the other. In particular, in the conventional FMM deposition method, the size of the FMM has to be equal to the size of a substrate. Thus, the size of the FMM has to be increased as the substrate becomes larger. However, it is neither straightforward to manufacture a large FMM nor to extend an FMM to have the FMM be accurately aligned with a pattern.

In order to overcome this problem, in the thin film deposition assembly 900 according to the current embodiment of the present invention, deposition may be performed while the thin film deposition assembly 900 or the substrate 400 is moved relative to the other. In other words, deposition may be continuously performed while the substrate 400, which is disposed such as to face the thin film deposition assembly 900, is moved in a Y-axis direction. In other words, deposition is performed in a scanning manner while the substrate 400 is moved in the direction of arrow A in FIG. 8. Although the substrate 400 is illustrated as being moved in the Y-axis direction in FIG. 8 when deposition is performed, the present invention is not limited thereto. Deposition may be performed while the thin film deposition assembly 900 is moved in the Y-axis direction, whereas the substrate 400 is fixed.

Thus, in the thin film deposition assembly 900 according to the current embodiment of the present invention, the patterning slit sheet 950 may be significantly smaller than an FMM used in a conventional deposition method. In other words, in the thin film deposition assembly 900 according to the current embodiment of the present invention, deposition is continuously performed, i.e., in a scanning manner while the substrate 400 is moved in the Y-axis direction. Thus, lengths of the patterning slit sheet 950 in the X-axis and Y-axis directions may be significantly less than the lengths of the substrate 400 in the X-axis and Y-axis directions. As described above, since the patterning slit sheet 950 may be formed to be significantly smaller than an FMM used in a conventional deposition method, it is relatively easy to manufacture the patterning slit sheet 950 used in the present invention. In other words, using the patterning slit sheet 950, which is smaller than an FMM used in a conventional deposition method, is more convenient in all processes, including etching of the patterning slit sheet 950 and subsequent other processes, such as precise extension, welding, moving, and cleaning processes, compared to the conventional deposition method using the larger FMM. This is more advantageous for a relatively large display device.

In order to perform deposition while the thin film deposition assembly 900 or the substrate 400 is moved relative to the other as described above, the thin film deposition assembly 900 and the substrate 400 may be separate from each other by a predetermined distance. This will be described later in detail.

The deposition source 910 that contains and heats the deposition material 915 is disposed in an opposite side of the chamber to that in which the substrate 400 is disposed. As the deposition material 915 contained in the deposition source 910 is vaporized, the deposition material 915 is deposited on the substrate 400.

In particular, the deposition source 910 includes a crucible 911 that is filled with the deposition material 915, and a heater 912 that heats the crucible 911 to vaporize the deposition material 915, which is contained in the crucible 911, towards a side of the crucible 911, and in particular, towards the deposition source nozzle unit 920.

The deposition source nozzle unit 920 is disposed at a side of the deposition source 910, and in particular, at the side of the deposition source 910 facing the substrate 400. The deposition source nozzle unit 920 includes a plurality of deposition source nozzles 921 arranged at equal intervals in the Y-axis direction. The deposition material 915 that is vaporized in the deposition source 910, passes through the deposition source nozzle unit 920 towards the substrate 400 that is the deposition target. As described above, when the plurality of deposition source nozzles 921 are formed on the deposition source nozzle unit 920 in the Y-axis direction, that is, the scanning direction of the substrate 400, the size of the pattern formed by the deposition material that is discharged through each of patterning slits 951 in the patterning slit sheet 950 is only affected by the size of one deposition source nozzle 921, that is, it may be considered that one deposition nozzle 921 exists in the X-axis direction, and thus there is no shadow zone on the substrate 400. In addition, since the plurality of deposition source nozzles 921 are formed in the scanning direction of the substrate 400, even though there is a difference between fluxes of the deposition source nozzles 921, the difference may be compensated and deposition uniformity may be maintained constantly.

The patterning slit sheet 950 and a frame 955 in which the patterning slit sheet 950 is bound are disposed between the deposition source 910 and the substrate 400. The frame 955 may be formed in a lattice shape, similar to a window frame. The patterning slit sheet 950 is bound inside the frame 955. The patterning slit sheet 950 includes the plurality of patterning slits 951 arranged in the X-axis direction. The deposition material 915 that is vaporized in the deposition source 910, passes through the deposition source nozzle unit 920 and the patterning slit sheet 950 toward the substrate 400. The patterning slit sheet 950 may be manufactured by etching, which is the same method as used in a conventional method of manufacturing an FMM, and in particular, a striped FMM. Here, the total number of patterning slits 951 may be greater than the total number of deposition source nozzles 921. As shown, each patterning slit 951 includes sub-slits 951a, 951b. The number of sub-slits 951a, 951b can be the same, or can be different according to a location relative to the edge of the patterning slit sheet 950. A separation between the sub-slits 951a, 951b is less than a separation between adjacent patterning slits 951.

On the other hand, the deposition source 910 (and the deposition source nozzle unit 920 coupled to the deposition source 910) and the patterning slit sheet 950 may be formed to be separate from each other by a predetermined distance. Alternatively and as shown, the deposition source 910 (and the deposition source nozzle unit 920 coupled to the deposition source 910) and the patterning slit sheet 950 are connected by connection members 935. That is, the deposition source 910, the deposition source nozzle unit 920, and the patterning slit sheet 950 are formed integrally with each other by being connected to each other via the connection members 935. The connection member 935 guides the deposition material 915, which is discharged through the deposition source nozzles 921, to move straight, not to flow in the X-axis direction. In FIGS. 8 through 10, the connection members 935 are formed on left and right sides of the deposition source 910, the deposition source nozzle unit 920, and the patterning slit sheet 950 to guide the deposition material 915 not to flow in the X-axis direction, however, the present invention is not limited thereto. That is, the connection member 935 may be formed as a sealed type of a box shape to guide flow of the deposition material 915 in the X-axis and Y-axis directions.

As described above, the thin film deposition apparatus 900 according to the current embodiment of the present invention performs deposition while being moved relative to the substrate 400. In order to move the thin film deposition apparatus 900 relative to the substrate 400, the patterning slit sheet 950 is separate from the substrate 400 by a predetermined distance.

In particular, in a conventional deposition method using an FMM, deposition is performed with the FMM in close contact with a substrate in order to prevent formation of a shadow zone on the substrate. However, when the FMM is used in close contact with the substrate, the contact may cause defects. In addition, in the conventional deposition method, the size of the mask has to be the same as the size of the substrate since the mask cannot be moved relative to the substrate. Thus, the size of the mask has to be increased as display devices become larger. However, it is not easy to manufacture such a large mask. In order to overcome this problem, in the thin film deposition apparatus 900 according to the current embodiment of the present invention, the patterning slit sheet 950 is disposed to be separate from the substrate 400 by a predetermined distance.

As described above, according to aspects of the present invention, a mask is formed to be smaller than a substrate, and deposition is performed while the mask is moved relative to the substrate. Thus, the mask can be easily manufactured. In addition, defects caused due to the contact between a substrate and an FMM, which occurs in the conventional deposition method, may be prevented. In addition, since it is unnecessary to use the FMM in close contact with the substrate during a deposition process, the manufacturing speed may be improved.

Although not illustrated, in the thin film deposition apparatus 900 according to the current embodiment of the present invention, a distance between the adjacent second slits 951 becomes smaller as the second slits 951 are arranged to be farther away from a center of the second nozzle 950. In contrast to the case when the adjacent second slits 951 are arranged in the second nozzle 950 at equal intervals as shown, all of the second slits 951 are slightly moved away from the center of the second nozzle 950, and the distance between the adjacent second slits 951 is made smaller as the second slits 951 are arranged to be farther away from the center of the second nozzle 950. As a result, the whole amount of pattern shift is reduced. Since the second slits 951 of the second nozzle 950 have been described in detail in the previous embodiment as shown in FIGS. 6A and 6B, a detailed description thereof will not be provided here.

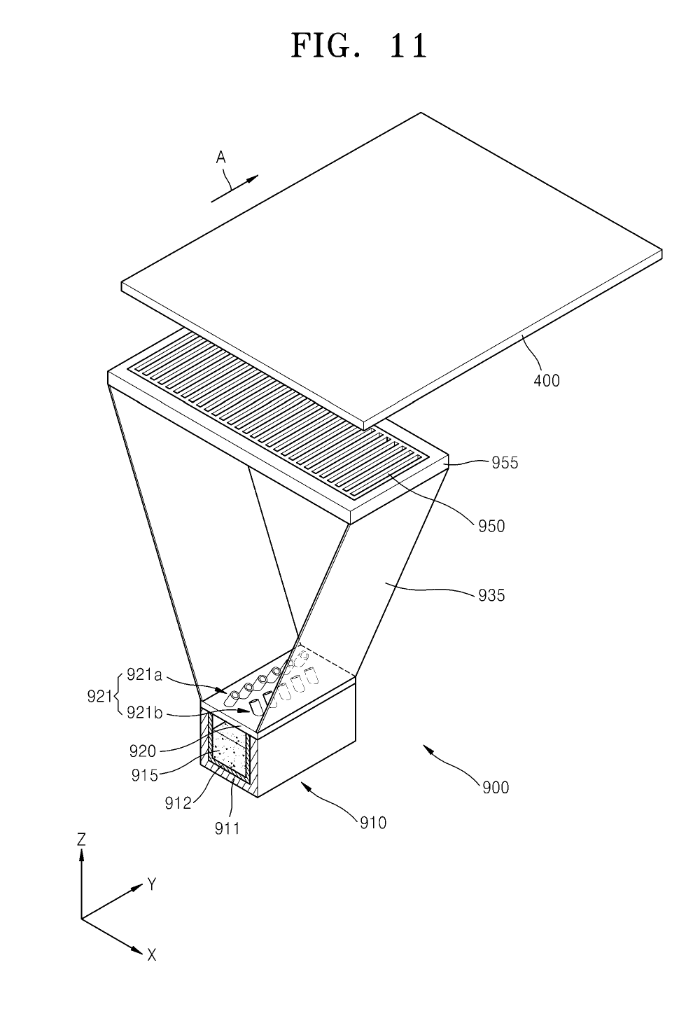

FIG. 11 is a schematic perspective view of the thin film deposition apparatus 900 according to another embodiment of the present invention. Referring to FIG. 11, the thin film deposition apparatus 900 according to the current embodiment of the present invention includes a deposition source 910, a deposition source nozzle unit 920, and a patterning slit sheet 950. In particular, the deposition source 910 includes a crucible 911 that is filled with the deposition material 915, and a heater 912 that heats the crucible 911 to vaporize the deposition material 915, which is contained in the crucible 912, towards a side of the crucible 911, and in particular, towards the deposition source nozzle unit 920. The deposition source nozzle unit 920, which has a planar shape, is disposed at a side of the deposition source 910. The deposition source nozzle unit 920 includes a plurality of deposition source nozzles 921 arranged in the Y-axis direction. The patterning slit sheet 950 and a frame 955 are further disposed between the deposition source 910 and the substrate 400, and the patterning slit sheet 950 includes a plurality of patterning slits 951 arranged in the X-axis direction. In addition, the deposition source 910, the deposition source nozzle unit 920, and the patterning slit sheet 950 are connected to each other by the connection member 935.

In the current embodiment of the present invention, the plurality of deposition source nozzles 920 formed on the deposition source nozzle unit 921 are tilted at a predetermined angle. In particular, the deposition source nozzles 921 may include deposition source nozzles 921a and 921b which are arranged in two rows, which are alternately arranged with each other. Here, the deposition source nozzles 921a and 921b may be tilted at a predetermined angle on an X-Z plane.

That is, in the current embodiment of the present invention, the deposition source nozzles 921a and 921b are arranged in tilted states at a predetermined angle. Here, the deposition source nozzles 921a in a first row may be tilted toward the deposition nozzles 921b in a second row, and the deposition source nozzles 921b in the second row may be tilted toward the deposition source nozzles 921 a in the first row. That is, the deposition source nozzles 921a arranged in the row at the left side of the patterning slit sheet 950 are arranged to face the right side of the patterning slit sheet 950, and the deposition source nozzles 921 b arranged in the row at the right side of the patterning slit sheet 950 are arranged to face the left side of the patterning slit sheet 950. The patterning slits sheet 950 can be the embodiments described with respect to the thin film deposition assembly 900 shown in FIGS. 8-10,

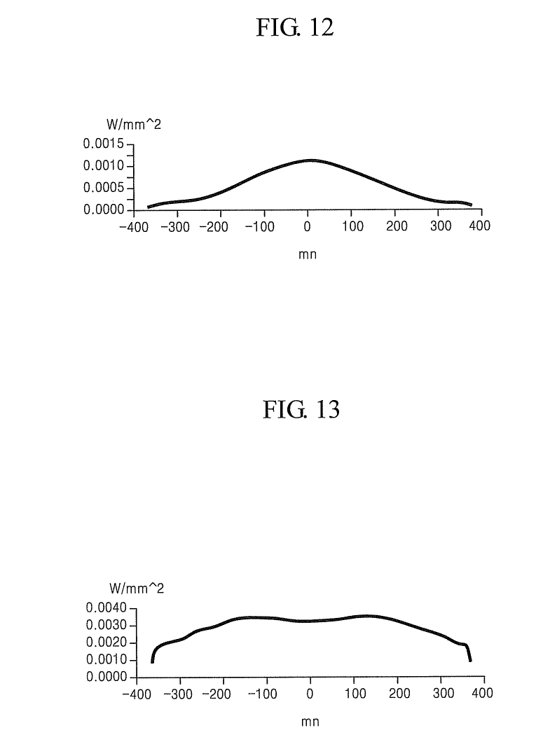

FIG. 12 is a graph illustrating a thickness distribution of a deposition layer formed on the substrate 400 when the deposition source nozzles 921 were not tilted, in the thin film deposition apparatus 900 according to the current embodiment of the present invention, and FIG. 13 is a graph showing a thickness distribution of a deposition layer formed on the substrate 400 when the deposition source nozzles 921 were tilted, in the thin film deposition apparatus 900 according to this embodiment of the present invention. Comparing the graphs of FIGS. 12 and 13 with each other, the thickness of both sides of the deposition layer formed on the substrate 400 when the deposition source nozzles 921 are tilted is relatively greater than that of both sides of the deposition layer formed on the substrate 400 when the deposition source nozzles 921 are not tilted, and thus, the uniformity of the thin film is improved when the deposition source nozzles 921a and 921b are tilted.

Therefore, the deposition amount of the deposition material may be adjusted so that the difference between the thickness of the center portion in the thin film and thickness of the both sides of the thin film formed on the substrate may be reduced and the entire thickness of the thin film may be constant, and moreover, the efficiency of utilizing the deposition material may be improved.

Although not illustrated, in the thin film deposition apparatus 900 according to the current embodiment of the present invention, a distance between the adjacent second slits 951 becomes smaller as the second slits 951 are arranged to be farther away from a center of the second nozzle 950. In contrast to the case when the second slits 951 are arranged in the second nozzle 950 at equal intervals as shown, all of the second slits 951 are slightly moved to the center of the second nozzle 950, and the distance between the adjacent second slits 951 is made smaller as the second slits 951 are arranged to be farther away from the center of the second nozzle 950. As a result, the whole amount of pattern shift is reduced. Since the second slits 951 of the second nozzle 950 have been described in detail in the previous embodiment as shown in FIGS. 6A and 6B, a detailed description thereof will not be provided here.

Although a few embodiments of the present invention have been shown and described, it would be appreciated by those skilled in the art that changes may be made in this embodiment without departing from the principles and spirit of the invention, the scope of which is defined in the claims and their equivalents.

1. A thin film deposition apparatus comprising:
a deposition source;
a first nozzle that is disposed at a side of the deposition source and comprises a plurality of first slits arranged in a first direction;
a second nozzle that is disposed opposite to the first nozzle and comprises a plurality of second slits arranged in the first direction; and
a barrier wall assembly that is disposed between the first nozzle and the second nozzle, and comprises a plurality of barrier walls arranged in the first direction that partition a space between the first nozzle and the second nozzle into a plurality of sub-deposition spaces,
wherein a distance between an adjacent pair of the second slits is different from a distance between another adjacent pair of the second slits.

2. The thin film deposition apparatus of claim 1, wherein, within each sub-deposition space, the distance between the adjacent second slits decreases as a distance between a center of the sub-deposition space and each of the second slits increases.

3. The thin film deposition apparatus of claim 1, wherein, within each sub-deposition space, the distance between the adjacent second slits decreases as a distance between each of the second slits and each of the first slits within the sub-deposition space increases.

4. The thin film deposition apparatus of claim 1, wherein the second slits are farther apart at a center of each sub-deposition space.

5. The thin film deposition apparatus of claim 4, wherein the second slits are closer together as the distance between the center of each sub-deposition space and each second slit increases.

6. The thin film deposition apparatus of claim 1, wherein each of the barrier walls extends in a second direction that is substantially perpendicular to the first direction, in order to partition the space between the first nozzle and the second nozzle into the plurality of sub-deposition spaces.

7. The thin film deposition apparatus of claim 1, wherein the plurality of barrier walls are arranged at equal intervals.

8. The thin film deposition apparatus of claim 1, wherein the barrier walls are separated from the second nozzle by a predetermined distance.

9. The thin film deposition apparatus of claim 1, wherein the barrier wall assembly is detachable from the thin film deposition apparatus.

10. The thin film deposition apparatus of claim 1, wherein each of the barrier wall assemblies comprises a first barrier wall assembly comprising a plurality of first barrier walls, and a second barrier wall assembly comprising a plurality of second barrier walls.

11. The thin film deposition apparatus of claim 10, wherein each of the first barrier walls and each of the second barrier walls extend in a second direction that is substantially perpendicular to the first direction, in order to partition the space between the first nozzle and the second nozzle into the plurality of sub-deposition spaces.

12. The thin film deposition apparatus of claim 10, wherein the first barrier walls are arranged to respectively correspond to the second barrier walls.

13. The thin film deposition apparatus of claim 12, wherein each pair of the first and second barrier walls corresponding to each other is arranged on substantially the same plane.

14. The thin film deposition apparatus of claim 1, wherein:
one of the first slits and a plurality of the second slits are arranged in each sub-deposition space, and
the distance between the adjacent second slits decreases within each sub-deposition space as the distance between each of the second slits and the one the first slit increases.

15. The thin film deposition apparatus of claim 1, wherein the second nozzle is separated a predetermined distance from a target on which a deposition material vaporized in the deposition source is deposited.

16. The thin film deposition apparatus of claim 1, wherein the deposition source, the first nozzle, the second nozzle, and the barrier wall assembly are movable relative to a target on which a deposition material vaporized in the deposition source is deposited, or the target is movable relative to the deposition source, the first nozzle, the second nozzle, and the barrier wall assembly.

17. The thin film deposition apparatus of claim 16, wherein the deposition material is deposited on the target while the deposition source, the first nozzle, the second nozzle, and the barrier wall assembly are moved relative to the target or while the target is moved relative to the deposition source, the first nozzle, the second nozzle, and the barrier wall assembly.

18. The thin film deposition apparatus of claim 16, wherein the deposition source, the first nozzle, the second nozzle, and the barrier wall assembly are moved relative to the target along a plane parallel to a surface of the target, or the target is moved relative to the deposition source, the first nozzle, the second nozzle, and the barrier wall assembly along the plane.

19. A thin film deposition apparatus for forming a thin film on a target, the apparatus comprising:
a deposition source;
a first nozzle that is disposed at a side of the deposition source and comprises a plurality of first slits arranged in a first direction;
a second nozzle that is disposed opposite to the first nozzle and comprises a plurality of second slits arranged in the first direction; and
a barrier wall assembly that comprises a plurality of barrier walls arranged between the first nozzle and the second nozzle,
wherein:
the second nozzle is separated from the target by a predetermined distance, and
a distance between an adjacent pair of the second slits is different from a distance between another adjacent pair of the second slits.

20. The thin film deposition apparatus of claim 19, wherein each of the barrier walls are arranged in the first direction between the first nozzle and the second nozzle, in order to partition the space between the first nozzle and the second nozzle into a plurality of sub-deposition spaces.

21. The thin film deposition apparatus of claim 20, wherein, in each of the sub-deposition spaces, the distance between the adjacent second slits decreases as a distance between a center of the sub-deposition space and each of the second slits increases.

22. The thin film deposition apparatus of claim 20, wherein, in each of the sub-deposition spaces, the distance between the adjacent second slits decreases as a distance between each of the second slits and each of the first slits arranged in the sub-deposition space increases.

23. The thin film deposition apparatus of claim 20, wherein the second slits are farther apart at a center of each sub-deposition space.

24. The thin film deposition apparatus of claim 23, wherein the second slits are closer together as the distance between the center of each sub-deposition space and each second slit increases.

25. The thin film deposition apparatus of claim 19, wherein the plurality of barrier walls are arranged at equal intervals.

26. The thin film deposition apparatus of claim 19, wherein the barrier walls are separated from the second nozzle by a predetermined distance.

27. The thin film deposition apparatus of claim 19, wherein the barrier wall assembly is detachable from the thin film deposition apparatus.

28. The thin film deposition apparatus of claim 19, wherein the barrier wall assembly comprises a first barrier wall assembly comprising a plurality of first barrier walls, and a second barrier wall assembly comprising a plurality of second barrier walls.

29. The thin film deposition apparatus of claim 28, wherein each of the first barrier walls and each of the second barrier walls extend in a second direction that is substantially perpendicular to the first direction, in order to partition the space between the first nozzle and the second nozzle into the plurality of sub-deposition spaces.

30. The thin film deposition apparatus of claim 28, wherein the first barrier walls are arranged to respectively correspond to the second barrier walls.

31. The thin film deposition apparatus of claim 30, wherein each pair of the first and second barrier walls corresponding to each other is arranged on substantially the same plane.

32. The thin film deposition apparatus of claim 20, wherein:
each sub-deposition space includes one of the first slits and a plurality of the second slits, and
in each sub-deposition space, the distance between the adjacent second slits decreases as the distance between each of the second slits and the one first slit increases.

33. The thin film deposition apparatus of claim 19, wherein the deposition source, the first nozzle, the second nozzle, and the barrier wall assembly are movable relative to the target on which a deposition material vaporized in the deposition source is deposited, or the target is movable relative to the deposition source, the first nozzle, the second nozzle, and the barrier wall assembly.

34. The thin film deposition apparatus of claim 33, wherein the deposition material is deposited on the target while the deposition source, the first nozzle, the second nozzle, and the barrier wall assembly are moved relative to the target or while the target is moved relative to the deposition source, the first nozzle, the second nozzle, and the barrier wall assembly.

35. The thin film deposition apparatus of claim 33, wherein the deposition source, the first nozzle, the second nozzle, and the barrier wall assembly are moved relative to the target along a plane parallel to a surface of the target, or the target is moved relative to the deposition source, the first nozzle, the second nozzle, and the barrier wall assembly along the plane.

36. A thin film deposition apparatus for forming a thin film on a substrate, the apparatus comprising:
a deposition source that discharges a deposition material;
a deposition source nozzle unit disposed at a side of the deposition source and including a plurality of deposition source nozzles arranged in a first direction; and
a patterning slit sheet disposed opposite to the deposition source nozzle unit and including a plurality of patterning slits arranged in a second direction perpendicular to the first direction, wherein:
a deposition is performed while the substrate or the thin film deposition apparatus moves relative to the other in the first direction,
the deposition source, the deposition source nozzle unit, and the patterning slit sheet are formed integrally with each other, and
each of the patterning slits includes a plurality of sub-slits.

37. The thin film deposition apparatus of claim 36, wherein, within each sub-deposition space, the distance between the adjacent patterning slits decreases as a distance between a center of the sub-deposition space and each of the patterning slits increases.

38. The thin film deposition apparatus of claim 36, wherein, within each sub-deposition space, the distance between the adjacent patterning slits decreases as a distance between each of the patterning slits and each of the deposition source nozzles within the sub-deposition space increases.

39. The thin film deposition apparatus of claim 36, wherein the patterning slits are farther apart at a center of each sub-deposition space.

40. The thin film deposition apparatus of claim 39, wherein the patterning slits are closer together as the distance between the center of each sub-deposition space and each patterning slit increases.

41. The thin film deposition apparatus of claim 36, wherein the deposition source and the deposition source nozzle unit, and the patterning slit sheet are connected to the other by a connection member.

42. The thin film deposition apparatus of claim 41, wherein the connection member guides movement of the discharged deposition material.

43. The thin film deposition apparatus of claim 41, wherein the connection member seals the space between the deposition source and the deposition source nozzle unit, and the patterning slit sheet.

44. The thin film deposition apparatus of claim 36, wherein the thin film deposition apparatus is separate from the substrate by a predetermined distance.

45. The thin film deposition apparatus of claim 36, wherein the deposition material discharged from the thin film deposition apparatus is continuously deposited on the substrate while the substrate or the thin film deposition apparatus is moved relative to the other in the first direction.

46. The thin film deposition apparatus of claim 36, wherein the patterning slit sheet of the thin film deposition apparatus is smaller than the substrate.

47. The thin film deposition apparatus of claim 36, wherein the plurality of deposition source nozzles are tilted at a predetermined angle.

48. The thin film deposition apparatus of claim 47, wherein the plurality of deposition source nozzles includes deposition source nozzles arranged in two rows formed in the first direction, and the deposition source nozzles in the two rows are tilted to face each other.

49. The thin film deposition apparatus of claim 47, wherein the plurality of deposition source nozzles include deposition source nozzles arranged in two rows formed in the first direction, the deposition source nozzles arranged in the row located at a first side of the patterning slit sheet are arranged to face a second side of the patterning slit sheet, and the deposition source nozzles arranged in the other row located at the second side of the patterning slit sheet are arranged to face the first side of the patterning slit sheet.

50. A method of forming a thin film on a substrate, the method comprising:
passing a deposition material from a deposition source through a first nozzle comprising a plurality of first slits arranged in a first direction;
passing the deposition material from the first nozzle through a space to a second nozzle comprising a plurality of second slits arranged in the first direction; and
forming a pattern on the substrate using the deposition material passed from the second nozzle, wherein a first distance between an adjacent pair of the second slits is different from a second distance between another adjacent pair of the second slits according to a relationship which reduces pattern shift during deposition due to a relative distance between the first slits and the corresponding second slits.

51. The method of claim 50, wherein the another adjacent pair of the second slits is farther from a common position than the adjacent pair of the second slits, and the first distance is greater than the second distance.

52. The method of claim 50, further comprising barrier walls arranged in the first direction that partition a space between the first nozzle and the second nozzle into a plurality of sub-deposition spaces, wherein, within each sub-deposition space, a distance between adjacent pairs of the second slits varies according to a distance from a common position of the sub-deposition space.

53. The method of claim 52, wherein the distance decreases the farther from the adjacent pair of second slits are from the common position.

54. The method of claim 52, wherein the common position corresponds to one of the first slits disposed within the sub-deposition space.

55. The method of claim 54, wherein the one first slit in the sub-deposition space is substantially at a center of the sub-deposition space in the first direction.
